(19) United States
(12) Patent Application Publication
(10) Pub. No.: US 2016/0187630 A1
(43) Pub. Date: Jun. 30, 2016

(54) TELEPHOTO LENS SYSTEM

(71) Applicant: Sekonix Co., Ltd., Dongducheon-Si (KR)

(72) Inventors: Soon Chul Choi, Namyangju-si (KR); Hyeoung S. Ham, Dongducheon-Si (KR); Du H. Lee, Pyeongtaek-Si (KR); Tae E. Park, Dongducheon-Si (KR)

(73) Assignee: Sekonix Co., Ltd., Dongducheon-Si (KR)

(21) Appl. No.: 14/684,020

(22) Filed: Apr. 10, 2015

(30) Foreign Application Priority Data
Dec. 30, 2014 (KR) 10-2014-0193656

(51) Int. Cl. G02B 17/08

(52) U.S. Cl. CPC G02B 17/086; G02B 17/0808

(57) ABSTRACT

A telephoto lens system including a lens disposed on an optical axis from an object. A front part of the lens includes a reflecting area in a central portion and a transmitting area in a circumferential portion. A rear part of the lens includes a concave transmitting area in central portion and a reflecting area in a circumferential portion. The lens is formed of a single material. A single lens has a plurality of reflecting areas and a plurality of transmitting areas in order to reduce the length of the lens and increase a focal length, thereby reducing the length of the entire telephoto lens system. The angle of light with respect to the optical axis is controlled to improve imaging, thereby improving the performance of the optical system. A small but high-definition telephoto lens system is provided.

### CROSS REFERENCE TO RELATED APPLICATION(S)

This application claims the benefit of Korean Patent Application No, 10-2014-0193656, filed on Dec. 30, 2014, which is hereby incorporated by reference in its entirety into this application.

### BACKGROUND OF THE INVENTION

1. Field of the Invention

The present invention generally relates to a telephoto lens system. More particularly, the present invention relates to a telephoto lens system in which a single lens plurality of reflecting areas and a plurality of transmitting areas in order to reduce the length of the lens and increase a focal length, thereby reducing the length of the entire telephoto lens system.

2. Description of the Related Art

A telephoto lens is a lens able to magnify a distant object such that the object is magnified at an angle of view smaller than a typical angle of view of people.

In general, this telephoto lens has a long total optical track length (TTL), i.e. a length from the summit of the front surface of a lens to an imaging surface.

This limitation in the length makes it difficult to mount the telephoto lens on thin devices such as smartphones.

U.S. Pat. No. 7,542,219 disclosed a lens system including six lenses, in which a focal length f is 67.74 mm, a total optical track length (TTL) is 68.53 mm, and TTL/f=1.01. In this case, the ratio of the TTL to the focal length is greater than one. When the focal length is scaled to about 14 mm, the total track length is 14.16 mm, which is inapplicable to thin smartphones.

In addition, U.S. Pat. No. 4,666,259 disclosed a catadioptric lens system including four lenses and two reflectors, which cannot be miniaturized.

The information disclosed in the Background of the Invention section is only for the enhancement of understanding of the background of the invention, and should not be taken as an acknowledgment or as any form of suggestion that this information forms a prior art that would already be known to a person skilled in the art.

### SUMMARY OF THE INVENTION

Accordingly, the present invention has been made keeping in mind the above problems occurring In the related art, and the present invention is intended to propose a telephoto lens system in which a single lens has a plurality of reflecting areas and a plurality of transmitting areas in order to reduce the length of the lens and increase a focal length, thereby reducing the length of the entire telephoto lens system.

In order to achieve the above object, according to one aspect of the present invention, there is provided a telephoto lens system including a lens disposed on an optical axis from an object. A front part of the lens includes a reflecting area in a central portion and a transmitting area in a circumferential portion. A rear part of the lens includes a concave transmitting area in a central portion and a reflecting area in a circumferential portion. The lens is formed of a single material.

The reflecting area in the front part of the lens may be concave in a direction toward the object.

The inner diameter of the reflecting area in the rear part of the lens may be greater than the outer diameter of the transmitting area in the rear part of the lens.

The transmitting area and the reflecting area in the rear part of the lens may be connected to each other via an inclined surface extending from an inner diameter of the reflecting area to an outer diameter of the transmitting area. The inclined surface may be shaped to converge forward about the optical axis.

The inclined surface may be provided with a light-blocking means. The inclined surface may have a stepped shape.

In light bundles emitted from the object on the optical axis, a ray of light propagating at a height corresponding to 90% of an effective diameter may be directed satisfying the following relationship: |ang3|>|ang4|×2, were ang3 indicates an angle of light reflected from the reflecting area in the rear part with respect to the optical axis, and ang4 indicates an angle of light reflected from the reflecting area in the front part with respect to the optical axis.

A relationship: TTL/f<0.4 may be satisfied, where TTL is a total optical track length or a length from a summit of a front surface of the lens to an imaging surface, and f is a focal length.

The lens may be formed of a plastic material.

The telephoto lens system may further include one to three rear lenses arranged on the optical axis and sequentially at a rear of the transmitting area of the rear part of the lens. The rear lens may be formed of a plastic material, at least one surface of the rear lens forming an aspheric lens.

According to the present invention as set forth above, a single lens has a plurality of reflecting areas and a plurality of transmitting areas in order to reduce the length of the lens and increase a focal length, thereby reducing the length of the entire telephoto lens system. The angle of light with respect to the optical axis is controlled to improve imaging, thereby improving the performance of the optical system. A small but high-definition telephoto lens system is provided.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a schematic view illustrating a telephoto lens system according to the present invention;

FIG. 2 is a diagram illustrating the first exemplary embodiment according to the telephoto lens system of the present invention;

FIG. 3 illustrates an aberration diagram according to the first exemplary embodiment of the present invention;

FIG. 4 is a schematic view illustrating a second exemplary embodiment according to the telephoto lens system of the present invention;

FIG. 5 illustrates an aberration diagram according to the second exemplary embodiment of the present invention;

FIG. 6 is a schematic view illustrating a third exemplary embodiment according to the telephoto lens system of the present invention;

FIG. 7 illustrates an aberration diagram according to the third exemplary embodiment of the present invention;

FIG. 8 is a schematic view illustrating a fourth exemplary embodiment according to the telephoto lens system of the present invention; and

FIG. 9 is a diagram illustrating an aberration according to the fourth exemplary embodiment of the present invention.

### DETAILED DESCRIPTION OF THE INVENTION

The present invention relates to a telephoto lens system of which the total optical track length (TTL), i.e. the length from the summit of the front surface of a lens to an imaging surface, is shorter than the focal length f. More particularly, the present invention relates to a telephoto lens system in which a single lens has a plurality of reflecting areas and a plurality of transmitting areas in order to reduce the total length of the lens and increase the focal length, thereby reducing the length of the entire telephoto lens system.

Reference will now be made in greater detail to the present invention in conjunction with the accompanying drawings.

An aspect of the present invention provides a telephoto lens system in which a lens is arranged on an optical axis from an object. The front part of the lens has a reflecting area in the central portion and a transmitting area in the circumferential portion, and the rear part of the lens has a concave transmitting area in the central portion and a reflecting area in the circumferential portion. The lens is formed of a single material.

A single lens is provided, and reflecting areas and the transmitting areas are provided in the front part and the rear part of the lens. More specifically, the reflecting areas are formed in the central portion of the front part and the circumferential portion of the rear part of the lens, whereas the transmitting areas are formed in the circumferential portion of the front part and the central portion of the rear part of the lens.

This geometry of the lens having the single lens reduces the length of the entire lens system while increasing the focal length, thereby enabling a small telephoto lens system to be provided.

A light bundle from an object on the optical axis first passes through the circumferential transmitting area (second surface) of the front part of the lens, is reflected from the circumferential reflecting area (third surface) of the rear part of the lens, is reflected again from the central reflecting area (fourth surface) of the front part of the lens, and subsequently passes through the central transmitting area (fifth surface) of the rear part of the lens, thereby forming an image on the imaging surface.

This structure reduces the length of the entire lens and increases the focal length, thereby improving the telephoto lens. This structure also enables a small telephoto lens system to be provided, such that a high-performance telephoto lens system is applicable to small electronics such as smartphones.

The reflecting area of the front part of the lens is concave in the direction toward the object such that light reflected from the circumferential reflecting area of the rear part of the lens is reflected again and converges, thereby increasing the focal length of the lens and facilitating the imaging.

It is preferable that the inner diameter of the circumferential reflecting area of the rear part of the lens is greater than the outer diameter of the central transmitting area of the rear part of the lens, and that the inner diameter of the circumferential reflecting area is connected to the outer diameter of the central transmitting area via an inclined surface. This structure allows the lens to be manufactured by injection molding.

Thus, the single lens is manufactured by forming the two reflecting surfaces and the two transmitting surfaces from a single material by injection molding.

The transmitting area of the rear part of the lens is formed concave such that the inclined surface converges forward about the optical axis.

This geometry intended to prevent light from the circumferential transmitting area (second surface) of the front part of the lens from arriving at a sensor directly through the transmitting area (fifth surface) of the rear part of the lens.

The inclined surface is coated with a light-blocking means, such as a black lacquer or a black bond, in order to prevent light that has passed through the circumferential transmitting area of the front part of the lens from passing through the inclined surface, thereby preventing unnecessary light such as a flare.

The inclined surface may be stepped in order to improve the light-blocking ability, thereby improving imaging performance.

In particular, the telephoto lens system according to the present invention is characterized in that, in light bundles emitted from the object on the optical axis, a ray of light propagating at a height corresponding to 90% of the effective diameter is directed satisfying the following relationship: |ang3|>|ang4|x2 , where ang3 indicates the angle of light reflected from the reflecting area of the rear part with respect to the optical axis, and ang4 indicates the angle of light reflected from the reflecting area of the front part with respect to the optical axis.

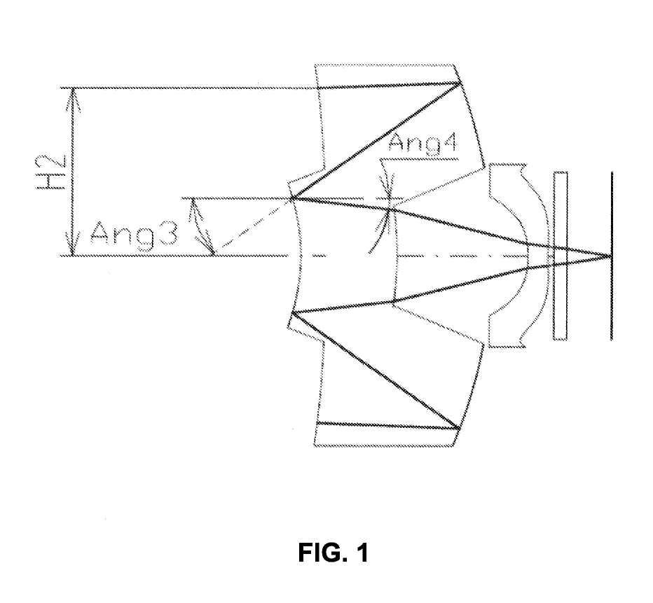

Specifically, as illustrated in FIG. 1, in a light bundle from among the light bundles emitted from the object on the optical axis, a ray of light propagating at a height H2 corresponding to 90% of the effective diameter passes through the circumferential transmitting area (second surface) of the front part of the lens, is reflected from the circumferential reflecting area (third surface) of the rear part of the lens, is directed to and reflected from the central reflecting area (fourth surface) of the front part of the lens, arid subsequently passes through the central transmitting area (fifth surface) of the rear part of the lens.

In this case, the ang3 indicates the angle of the light reflected from the third surface with respect to the optical axis, and the ang4 indicates the angle of the light reflected from the fourth surface with respect to the optical axis. The angle ang3 is set at least two times the angle ang4. When these conditions are satisfied, a long focal length can be realized.

The telephoto lens system according to the present invention is configured such that the length from the summit of the front surface of the lens to the imaging surface, i.e. the total optical track length (TTL), and the focal length f satisfy the following relationship: TTL/f<0. 4, thereby enabling the focal length to be significantly greater than the length of the entire lens system. The long focal length obtains the unique function of q telephoto lens while reducing the length of the entire lens system, thereby enabling a high-performance telephoto lens system.

In addition, in a telephoto lens system, one to three rear lenses may be disposed on the optical axis at the rear of the central transmitting area of the rear part of the lens in order to further improve imaging performance.

The rear lens may be fitted into the concave portion in the central transmitting area of the rear part of the lens. More specifically, the shape of the rear lens may correspond to the shape of the inclined surface such that the rear lens is engaged with the inclined surface, thereby further reducing the length of the lens system considering the focal length.

In addition, it is preferable that the lens used in this telephoto lens system is formed of a plastic material. It is also preferable that the rear lens is formed of a plastic material.

At least one surface of the rear lens forms an aspheric lens, thereby improving the imaging performance of the circumferential portion.

As described above, according to the present invention, a single lens has a plurality of transmitting areas and a plurality of the reflecting areas in order to reduce the length of the entire lens system while increasing the focal length. The angle of light with respect to the optical axis is controlled to facilitate the imaging. The performance of the optical system is improved, and the size of the entire optical system is reduced.

Exemplary embodiments of the present invention will be described below.

### First Embodiment

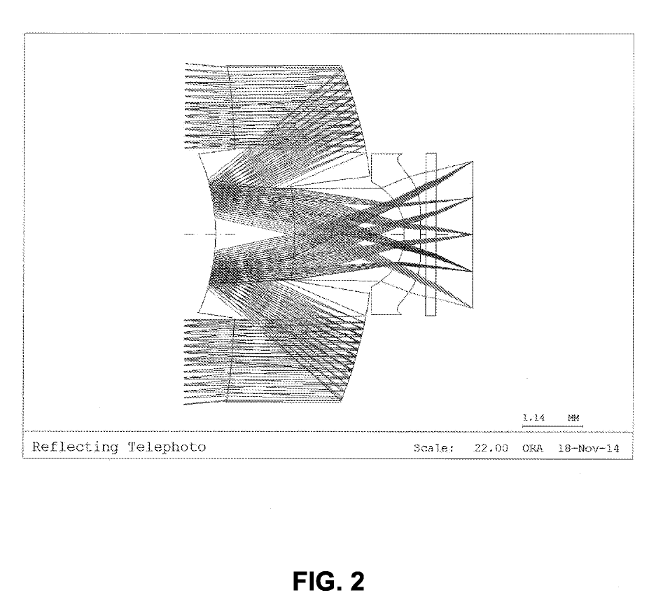

FIG. 2 is a diagram illustrating the first exemplary embodiment according to the telephoto lens system of the present invention.

As illustrated in FIG. 2, a lens is disposed on an optical axis at a predetermined distance from an object, and one rear lens compensating for imaging is additionally disposed at a position facing a transmitting area of a rear part of the lens.

Table 1 below presents data about the lens constituting an optical system according to the first embodiment of the present invention.

TABLE 1

| Surface | | THI | | | |
|---|---|---|---|---|---|
| No. | RDY¹⁾ | (thickness) | Nd²⁾ | Vd³⁾ | R/T⁴⁾ |
| OBJ | INFINITY | 20000 | | | |
| 1 | INFINITY | 0.482369 | AIR | | |
| 2 | −45.94112 | 2.6 | 1.531 | 55.8 | T⁵⁾ |
| STO | −8.45074 | −2.99424 | 1.531 | 55.8 | R⁶⁾ |
| 4 | −3.35712 | 1.5 | 1.531 | 55.8 | R⁶⁾ |
| 5 | −6 | 2.063 | air | | |
| 6 | −1.8 | 0.31 | 1.531 | 55.8 | T⁵⁾ |
| 7 | 6.00038 | 0.1 | air | | |
| 8 | INFINITY | 0.2 | BSC7_HOYA | | T⁵⁾ |
| 9 | INFINITY | 0.7 | | | |
| IMG | INFINITY | −0.003 | | | |

Notes)
RDY¹⁾: RDY (radius of curvature),
Nd²⁾: Nd (refractive index),
Vd³⁾: Vd (Abbe number),
R/T⁴⁾: Reflection/Transmission,
T⁵⁾: Transmission,
R⁶⁾: Reflection
(OBJ: Surface of object,
STO: Iris diaphragm,
IMG: imaging surface,
Infinity: plane)

As illustrated in FIG. 2, the lens (a second surface, an STO, a fourth surface and a fifth surface), the rear lens (a sixth surface and a seventh surface), an optical filter OF (an eighth surface, a ninth surface) are disposed sequentially from the object. When the direction of the optical axis is set X and the direction perpendicular to the optical axis is set Y, an aspherical equation is as follows:

$$X ( Y ) = \frac{{Y}^{2}}{R} = \frac{1}{1 + \sqrt{1 - ( 1 + K ) {( \frac{Y}{R} )}^{2}}} + {AY}^{4} + {BY}^{6} + {CY}^{8} + {DY}^{10} + {EY}^{12} + {FY}^{14} \qquad [ Formula 1 ]$$

where an aspherical surface is a curved surface produced by rotating a curved line obtained from the aspherical equation of Formula 1 around the optical axis, R is a radius of curvature, K is a conic constant, and A, B, C, D, E, and F are aspherical coefficients.

Aspherical coefficients having data of each of the above-mentioned lenses obtained from Formula 1 are presented in Table 2 below.

TABLE 2

| | K | A | B | C | D |
|---|---|---|---|---|---|
| s2 | 0.00000E+00 | −7.50404E−04 | 1.93917E−05 | −7.40250E−07 | −1.58498E−08 |
| s3 | 0.00000E+00 | 9.92611E−05 | 4.58191E−06 | −1.61562E−07 | −2.43308E−09 |
| s4 | 0.00000E+00 | 1.07134E−02 | 2.31094E−04 | −8.74124E−04 | 1.32621E−04 |
| s5 | 0.00000E+00 | 5.66704E−03 | −6.06126E−03 | −1.66291E−03 | −1.82651E−04 |
| s6 | 0.00000E+00 | −4.42865E−01 | 2.69093E−01 | −1.80928E−01 | 4.48683E−02 |
| s7 | 0.00000E+00 | −4.01670E−01 | 2.86013E−01 | −1.55671E−01 | 3.78573E−02 |

Table 3 below presents the angle of view, height of image, focal length f, TTL, and TTL/f of the lens system according to the first embodiment. A high-performance telephoto lens with the focal length being at least three times the length of the entire lens system can be provided.

TABLE 3

| | |
|---|---|
| Angle of view | 10° |
| Height of image | 1.4 mm |
| Focal length (f) | 16.0 mm |
| TTL | 5.1 mm |
| TTL/f | 0.32 |

When referring to FIG. 1, in the lens (first lens) according to the first embodiment, H2 at a height corresponding to 90% of the effective diameter of the front part of the lens is 2.82 mm, ang3 is 36.6°, ang4 is 7°, and ang3/ang4 is 5.2.

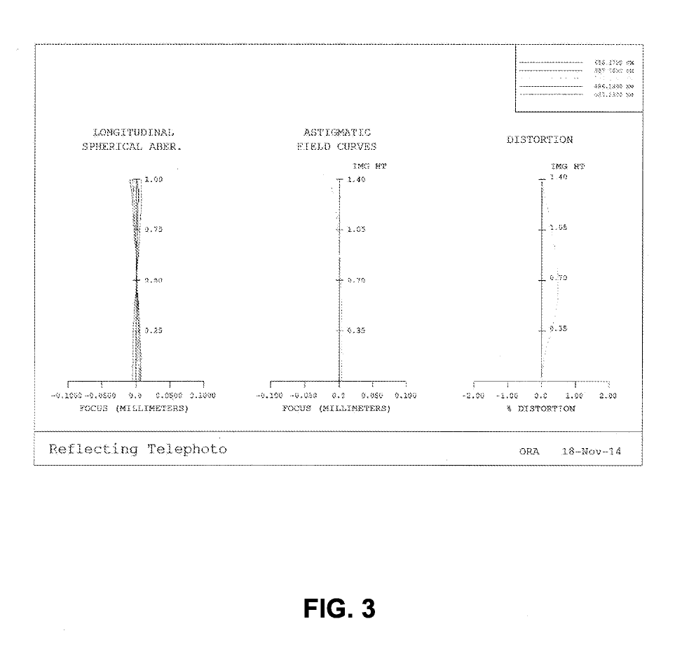

FIG. 3 illustrates an aberration diagram according to the first exemplary embodiment of the present invention.

Referring to FIG. 3, first data indicates spherical aberration, in which the vertical axis indicates a height of image (mm), the horizontal axis indicates a focus (mm) of each height of image, and the color of the graphs indicates the wavelength of incident light. As illustrated, it is known that the ability to correct spherical aberration is better as the graphs are closer to the central vertical axis and to each other. It is determined that the first embodiment of the present invention has a fine spherical aberration of 0.025 mm or less (focus).

Second data in FIG. 3 indicates astigmatism, in which the vertical axis indicates a height of image (mm), the horizontal axis indicates a focus (mm) of each height of image, graph S indicates sagittal light, i.e. a ray of light entering in the direction perpendicular to the ground, and graph T indicates tangential light, i.e. a ray of light entering in the direction parallel to the ground. It is known that the ability to correct astigmatism is better as the graphs S and T are closer to each other and to the central vertical axis. It is determined that the first, embodiment of the present invention has a fine spherical aberration of 0.025 mm or less (focus).

Third data in FIG. 3 indicates distortion, in which the horizontal axis indicates a degree of distortion (%), and the vertical axis indicates a focus (mm) of a height of image. It is known that an aberration curve ranging from −2 to 2% is desirable. From the distortion according to the first embodiment of the present invention, it is appreciated that the optical distortion is 1% or less, and that distortion correction ability is considerably good.

### Second Embodiment

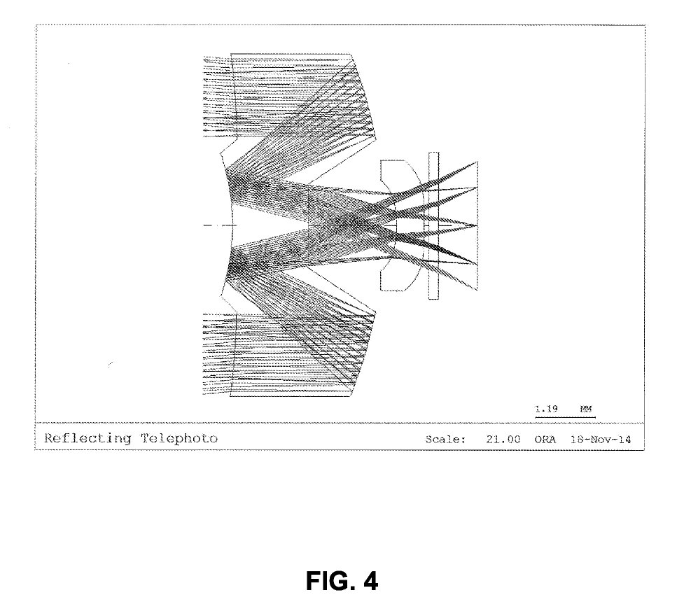

FIG. 4 is a schematic view illustrating a second exemplary embodiment according to the telephoto lens system of the present invention.

As illustrated in FIG. 4 a lens is disposed on an optical axis at a predetermined distance from an object, and one rear lens compensating for imaging is additionally disposed at a position facing a transmitting area of a rear part of the lens.

Table 4 below presents data about the lens constituting an optical system according to the second embodiment of the present invention.

TABLE 4

| Surface | | THI | | | |
|---|---|---|---|---|---|
| No. | RDY¹⁾ | (thickness) | Nd²⁾ | Vd³⁾ | R/T⁴⁾ |
| OBJ | INFINITY | INFINITY | | | |
| 1 | INFINITY | 0.182369 | AIR | | |
| 2 | −4453.28285 | 2.9 | 1.531 | 55.8 | T⁵⁾ |
| STO | −9.0419 | −2.99424 | 1.531 | 55.8 | R⁶⁾ |
| 4 | −4.18115 | 1.5 | 1.531 | 55.8 | R⁶⁾ |
| 5 | 45.18572 | 1.743948 | air | | |
| 6 | −2.90197 | 0.541768 | 1.531 | 55.8 | T⁵⁾ |
| 7 | 19.89573 | 0.1 | air | | |
| 8 | INFINITY | 0.2 | BSC7_HOYA | | T⁵⁾ |
| 9 | INFINITY | 0.78046 | | | |
| IMG | INFINITY | −0.002632 | | | |

Notes)
RDY¹⁾: RDY (radius of curvature),
Nd²⁾: Nd (refractive index),
Vd³⁾: Vd (Abbe number),
R/T⁴⁾: Reflection/Transmission,
T⁵⁾: Transmission,
R⁶⁾: Reflection
(OBJ: Surface of object,
STO: Iris diaphragm,
IMG: imaging surface,
Infinity: plane)

As illustrated in FIG. 4, the lens (a second surface, an STO, a fourth surface and a fifth surface), the rear lens (a sixth surface and a seventh surface), an optical filter OF (an eighth surface, a ninth surface) are disposed sequentially from the object. When the direction of the optical axis is set X and the direction perpendicular to the optical axis is set Y, an aspherical equation is as Formula 1 above.

In Formula 1, an aspherical surface is a curved surface produced by rotating a curved line obtained from the aspherical equation of Formula 1 around the optical axis, R is a radius of curvature, K is a conic constant, and A, B, C, D, E, and F are asbnerical coefficients.

Aspherical coefficients having data of each of the above-mentioned lenses obtained from Formula 1 are presented in Table 5 below.

TABLE 5

| | K | A | B | C | D |
|---|---|---|---|---|---|
| s2 | 0.00000E+00 | −9.97681E−04 | 1.70540E−06 | 1.19527E−07 | −1.99019E−08 |
| s3 | 0.00000E+00 | 5.93905E−06 | 2.46303E−07 | 7.92535E−08 | −7.16581E−09 |
| s4 | 0.00000E+00 | 6.06870E−03 | −7.00919E−04 | 3.87021E−04 | −1.85510E−04 |
| s5 | 0.00000E+00 | −8.34519E−04 | −8.66226E−03 | −8.90021E−05 | −8.04538E−04 |
| s6 | 0.00000E+00 | −2.12417E−01 | −3.74915E−02 | 2.31224E−02 | −4.87820E−02 |
| s7 | 0.00000E+00 | −1.79717E−01 | 3.22287E−02 | −1.06433E−02 | 7.15397E−04 |

Table 6 below presents the angle of view, height of image, focal length f, TTL, and TTL/f of the lens system according to the second embodiment. A high-performance telephoto lens with the focal length being at least three times the length of the entire lens system can be provided.

TABLE 6

| | |
|---|---|
| Angle of view | 10° |
| Height of image | 1.28 mm |
| Focal length (f) | 14.5 mm |
| TTL | 5.1 mm |
| TTL/f | 0.35 |

When referring to FIG. 1, in the lens (first lens) according to the second embodiment, H2 a height corresponding to 90%of the effective diameter of the front part of the lens is 2.74 mm, ang3 is 34.5°, ang4 is 9.5°, and ang3/ang4 is 3.6.

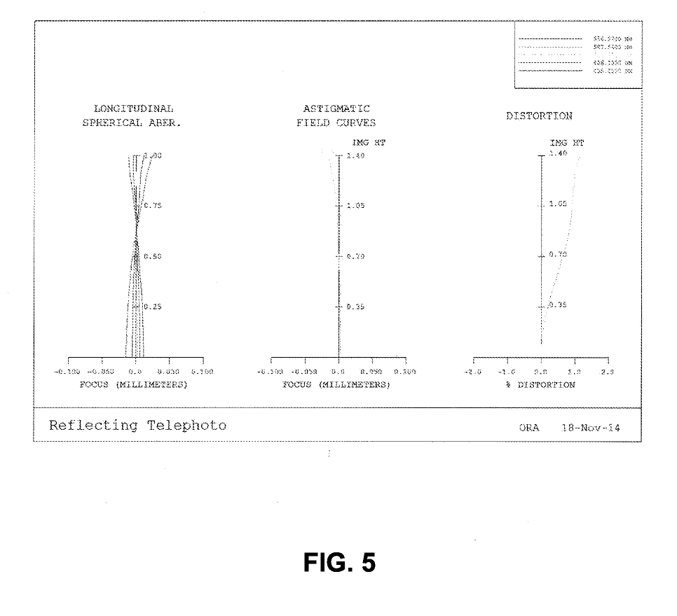

FIG. 5 illustrates an aberration diagram according to the second exemplary embodiment of the present invention.

Referring to FIG. 5, first data indicates spherical aberration, in which the vertical axis indicates a height of image (mm), the horizontal axis indicates a focus (mm) of each height of image, and the colors of the graphs indicate the wavelengths of incident light. As illustrated, it is known that the ability to correct spherical aberration is better as the graphs are closer to the central vertical axis and to each other. It is determined that the second embodiment of the present invention has a fine spherical aberration of 0.025 mm or less (focus).

Second data in FIG. 5 indicates astigmatism, in which the vertical axis indicates a height of image (mm), the horizontal axis indicates a focus (mm) of each height of image, graph S indicates sagittal light, i.e. a ray of light entering in the direction perpendicular to the ground, and graph T indicates tangential light, i.e. a ray of light entering in the direction parallel to the ground. It is known that the ability to correct astigmatism is better as the graphs S and T are closer to each other and to the central vertical axis. It is determined that the second embodiment of the present invention has a fine spherical. aberration of 0.025 mm or less (focus).

Third data in FIG. 5 indicates distortion, in which the horizontal axis indicates a degree of distortion (%), and the vertical axis indicates a focus (mm) of a height of image. It is known that an aberration curve ranging from −2 to 2% is desirable. From the distortion according to the second embodiment of the present invention, it is appreciated that the optical distortion is 1% or less, and that distortion correction ability is considerably good.

### Third Embodiment

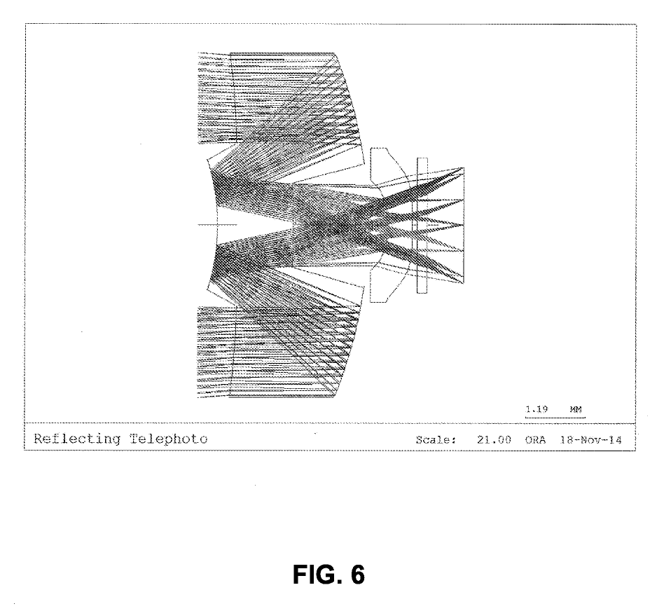

FIG. 6 is a schematic view illustrating a third exemplary embodiment according to the telephoto lens system of the present invention.

As Illustrated in FIG. 6, a lens is disposed on an optical axis at a predetermined distance from an object, and one rear lens compensating for imaging is additionally disposed at a position facing a transmitting area of a rear part of the lens.

Table 7 below presents data about the lens constituting an optical system according to the third embodiment of the present invention.

TABLE 7

| Surface | | THI | | | |
|---|---|---|---|---|---|
| No. | RDY¹⁾ | (thickness) | Nd²⁾ | Vd³⁾ | R/T⁴⁾ |
| OBJ | INFINITY | 14000 | | | |
| 1 | INFINITY | 0.3 | AIR | | |
| 2 | −201.64053 | 2.6 | 1.531 | 55.8 | T⁵⁾ |
| STO | −8.99403 | −2.99424 | 1.531 | 55.8 | R⁶⁾ |
| 4 | −4.10834 | 1.5 | 1.531 | 55.8 | R⁶⁾ |
| 5 | −26.89937 | 1.87744 | air | | |
| 6 | −2.5495 | 0.481332 | 1.531 | 55.8 | T⁵⁾ |
| 7 | 10.39629 | 0.1 | air | | |
| 8 | INFINITY | 0.2 | BSC7_HOYA | | T⁵⁾ |
| 9 | INFINITY | 0.704851 | | | |
| IMG | INFINITY | 0.013535 | | | |

Notes)
RDY¹⁾: RDY (radius of curvature),
Nd²⁾: Nd (refractive index),
Vd³⁾: Vd (Abbe number),
R/T⁴⁾: Reflection/Transmission,
T⁵⁾: Transmission,
R⁶⁾: Reflection
(OBJ: Surface of object,
STO: Iris diaphragm,
IMG: imaging surface,
Infinity: plane)

As illustrated in FIG. 6, the lens (a second surface, an STO, a fourth surface and a fifth surface), the rear lens (a sixth surface and a seventh surface), an optical filter OF (an eighth surface, a ninth surface) are disposed sequentially from the object. When the direction of the optical axis is set X and the direction perpendicular to the optical axis is set Y, an aspherical equation is as Formula 1 above.

In Formula 1, an aspherical surface is a curved surface produced by rotating a curved line obtained from the aspherical equation of Formula 1 around the optical axis, R is a radius of curvature, K is a conic constant, and A, B, C, D, E, and F are aspherical coefficients.

Aspherical coefficients having data of each of the above-mentioned lenses obtained from Formula 1 are presented in Table 8 below.

TABLE 8

| | K | A | B | C | D |
|---|---|---|---|---|---|
| s2 | 0.00000E+00 | −1.04242E−03 | 2.58760E−06 | 7.18689E−07 | 2.53491E−11 |
| s3 | 0.00000E+00 | 3.48143E−06 | 7.42060E−07 | 1.51871E−07 | −7.11450E−10 |
| s4 | 0.00000E+00 | 5.97627E−03 | −3.59986E−04 | 2.91393E−04 | −9.10370E−05 |
| s5 | 0.00000E+00 | −2.50724E−03 | −6.84358E−03 | 1.92008E−03 | −8.78405E−04 |
| s6 | 0.00000E+00 | −2.86045E−01 | 5.46572E−02 | −3.25038E−02 | −2.75161E−03 |
| s7 | 0.00000E+00 | −2.56393E−01 | 1.13061E−01 | −4.94938E−02 | 1.16991E−02 |

Table 9 below presents the angle of view, height of image, focal length f, TTL, and TTL/f of the lens system according to the first embodiment. A high-performance telephoto lens with the focal length being at least three times the length of the entire lens system can be provided.

TABLE 9

| | |
|---|---|
| Angle of view | 9° |
| Height of image | 1.15 mm |
| Focal length (f) | 14.5 mm |
| TTL | 5.1 mm |
| TTL/f | 0.35 |

When refrying to FIG. 1, in the lens (first lens) according to the third embodiment, H2 at a height corresponding to 90% of the effective diameter of the front part of the lens is 2.71 mm, ang3 is 34°, ang4 is 8.7°, and ang3/ang4 is 3.9.

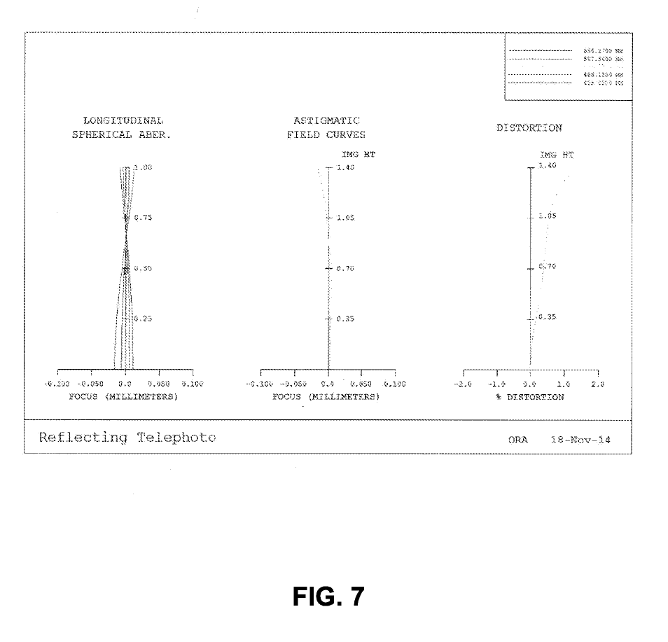

FIG. 7 illustrates an aberration diagram according to the third exemplary embodiment of the present invention.

Referring to FIG. 7, first data indicates spherical aberration, in which the vertical axis indicates a height of image (mm), the horizontal axis indicates a focus (mm) of each height of image, and the color of the graphs indicates the wavelength of incident light. As illustrated, it is known that the ability to correct spherical aberration is better as the graphs are closer to the central vertical axis and to each other. It is determined that the third embodiment of the present invention has a fine spherical aberration of 0.025 mm or less (focus).

Second data in FIG. 7 indicates astigmatism, in which the vertical axis indicates a height of image (mm), the horizontal axis indicates a focus (mm) of each height of image, graph S indicates sagittal light, i.e. a ray of light entering in the direction perpendicular to the ground, and graph T indicates tangential light, i.e. a ray of light entering in the direction parallel to the ground. It is known that the ability to correct astigmatism is better as the graphs S and T are closer to each other and to the central vertical axis. It is determined that the third embodiment of the present invention has a fine spherical aberration of 0.025 mm or less (focus).

Third data in FIG. 7 indicates distortion, in which the horizontal axis indicates a degree of distortion (%), and the vertical axis indicates a focus (mm) of a height of image. It is known that an aberration curve ranging from −2 to 2% is desirable. From the distortion according to the third embodiment of the present invention, it is appreciated that the optical distortion is 1% or less, and that distortion correction ability is considerably good.

### Fourth Embodiment

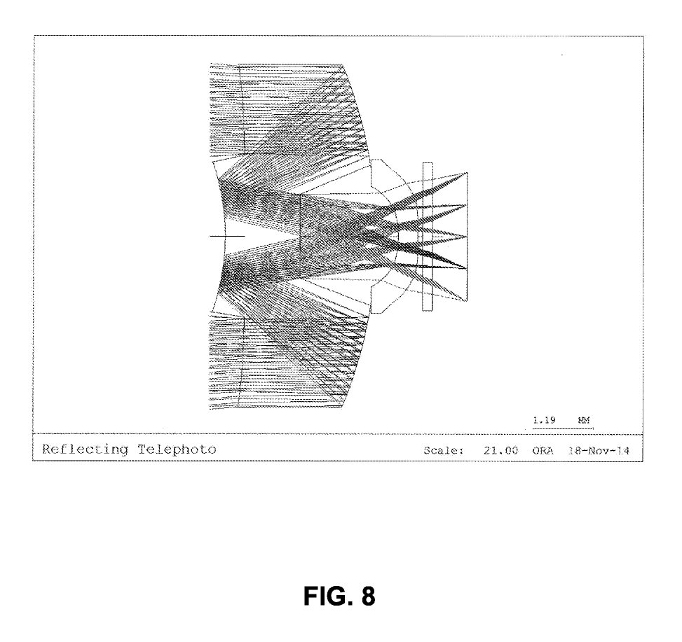

FIG. 8 is a schematic view illustrating a fourth exemplary embodiment according to the telephoto lens system of the present invention.

As illustrated in FIG. 8, a lens is disposed on an optical axis at a predetermined distance from an object, and one rear lens compensating for imaging is additionally disposed at a position facing a transmitting area of a rear part of the lens.

Table 10 below presents data about the lens constituting an optical system according to the fourth embodiment of the present invention.

TABLE 10

| Surface | | THI | | | |
|---|---|---|---|---|---|
| No. | RDY¹⁾ | (thickness) | Nd²⁾ | Vd³⁾ | R/T⁴⁾ |
| OBJ | INFINITY | INFINITY | | | |
| 1 | INFINITY | 0.232369 | AIR | | |
| 2 | −388.54339 | 2.6 | 1.531 | 55.8 | T⁵⁾ |
| STO | −9.02338 | −2.99424 | 1.531 | 55.8 | R⁶⁾ |
| 4 | −4.14517 | 1.5 | 1.531 | 55.8 | R⁶⁾ |
| 5 | −132.31302 | 1.92694 | air | | |
| 6 | −2.61904 | 0.387931 | 1.531 | 55.8 | T⁵⁾ |
| 7 | 10.90111 | 0.1 | air | | |
| 8 | INFINITY | 0.2 | BSC7_HOYA | | T⁵⁾ |
| 9 | INFINITY | 0.700006 | | | |
| IMG | INFINITY | −0.003 | | | |

Notes)
RDY¹⁾: RDY (radius of curvature),
Nd²⁾: Nd (refractive index),
Vd³⁾: Vd (Abbe number),
R/T⁴⁾: Reflection/Transmission,
T⁵⁾: Transmission,
R⁶⁾: Reflection
(OBJ: Surface of object,
STO: Iris diaphragm,
IMG: imaging surface,
Infinity: plane)

As illustrated in FIG. 8, the lens (a second surface, an STO, a fourth surface and a fifth surface), the rear lens (a sixth surface and a seventh surface), an optical filter OF (an eighth surface, a ninth surface) are disposed sequentially from the object. When the direction of the optical axis is set X and the direction perpendicular to the optical axis is set Y, an aspharical equation is as Formula 1 above.

In Formula 1, an aspherical surface is a curved surface produced by rotating a curved line obtained from the aspherical equation of Formula 1 around the optical axis, R is a radius of curvature, K is a conic constant, and A, B, C, D, E, and F are aspherical coefficients.

Aspherical coefficients having data of each of the above-mentioned lenses obtained from Formula 1 are presented in Table 11 below.

TABLE 11

| | K | A | B | C | D |
|---|---|---|---|---|---|
| s2 | 0.00000E+00 | −1.01875E−03 | 2.01890E−06 | 8.47762E−07 | −1.61329E−08 |
| s3 | 0.00000E+00 | 3.49953E−06 | 1.05216E−06 | 1.31130E−07 | −2.44448E−09 |
| s4 | 0.00000E+00 | 5.87674E−03 | −2.54069E−04 | 1.64495E−04 | −7.04123E−05 |
| s5 | 0.00000E+00 | −2.96374E−03 | −6.67567E−03 | 7.28588E−04 | −7.45974E−04 |
| s6 | 0.00000E+00 | −3.56880E−01 | 5.66138E−02 | −1.93745E−02 | −1.69200E−02 |
| s7 | 0.00000E+00 | −3.28451E−01 | 1.45589E−01 | −5.98002E−02 | 1.29282E−02 |

Table 12 below presents the angle of view, height of image, focal length f, TTL, and TTL/f of the lens system according to the fourth embodiment. A high-performance telephoto lens system with the focal length being at least three times the length of the entire lens system can be provided.

TABLE 12

| Angle of view | 10° | |
|---|---|---|
| Height of image | 1.4 | mm |
| Focal length (f) | 15 | mm |
| TTL | 5 | mm |

| | |
|---|---|
| TTL/f | 0.33 |

When referring to FIG. 1, in the lens (first lens) according to the fourth embodiment, H2 at a height corresponding to 90% of the effective diameter of the front part of the lens (first lens) is 2.76 mm, ang3 is 34.6°, ang4 is 9.2°, and ang3/ang4 is 3.8.

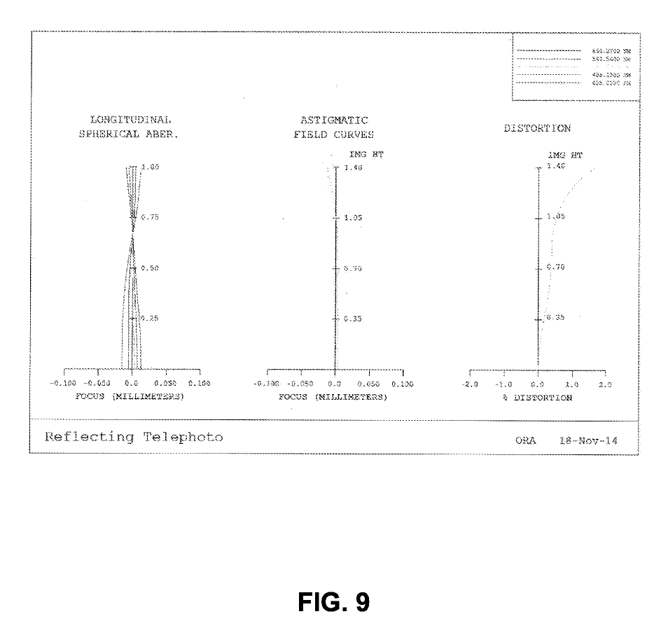

FIG. 9 is a diagram illustrating an aberration according to the fourth exemplary embodiment of the present invention.

Referring to FIG. 9, first data indicates spherical aberration, in which the vertical axis indicates a height of image (mm), the horizontal, axis indicates a focus (mm) of each height of image, and the color of the graphs indicates the wavelength of incident light. As illustrated, it is known that the ability to correct spherical aberration is better as the graphs are closer to the central vertical axis and to each other. It is determined that the fourth embodiment of the present invention has a fine spherical aberration of 0.025 mm or less (focus).

Second data in FIG. 9 indicates astigmatism, in which the vertical axis indicates a height of image (mm), the horizontal axis indicates a focus (mm) of each height of image, graph S indicates sagittal light, i.e. a ray of light entering in the direction perpendicular to the ground, and graph T indicates tangential light, i.e. a ray of light entering in the direction parallel to the ground. It is known that the ability to correct astigmatism is better as the graphs S and T are closer to each other and to the central vertical axis. It is determined that the fourth embodiment of the present invention has a fine spherical aberration of 0.025 mm or less (focus).

Third data in FIG. 9 indicates distortion, in which the horizontal axis indicates a degree of distortion (%), and the vertical axis indicates a focus (mm) of a height of image. It is known that an aberration curve ranging from −2 to 2% is desirable. From the distortion according to the second embodiment of the present invention, it is appreciated that the optical distortion is 1% or less except for 0.9 of the field or greater, and that distortion correction ability is considerably good.

As set forth above, the telephoto lens system according to embodiments of the invention has a plurality of reflecting areas and a plurality of transmitting areas in a single lens. The geometry and dimensions of the reflecting areas and the transmitting areas are defined to provide a focal length such that the ratio of the total optical track length (TTL) with respect to focal length f is smaller than 0.4 (TTL/f<0.4), wherein a small but high-definition telephoto lens system can be provided.

In particular, the lens is designed such that, in light bundles emitted from an object on the optical axis, a ray of light propagating at a height corresponding to 90% of the effective diameter is directed satisfying the following relationship: |ang3|>|ang4|×2 , where ang3 indicates the angle of light reflected from the reflecting area of the rear part with respect to the optical axis, and ang4 indicates the angle of light reflected from the reflecting area of the front part with respect to the optical axis. The telephoto lens system has an increased focal length while having superior spherical aberration, astigmatism, and distortion, which lead to superior imaging performance and high definition.

Although the exemplary embodiments of the present invention have been described for illustrative purposes, those skilled in the art will appreciate that various modifications, additions and substitutions are possible, without departing from the scope and spirit of the present invention as disclosed in the accompanying claims.

What is claimed:

1. A telephoto lens system comprising a lens disposed on an optical axis from an object, wherein
a front part of the lens comprises a reflecting area in a central portion and a transmitting area in a circumferential portion,
a rear part of the lens comprises a concave transmitting area in a central portion and a reflecting area in circumferential portion, and
the lens is formed of a single material.

2. The telephoto lens system according to claim 1, wherein the reflecting area in the front part of the lens is concave in a direction toward the object.

3. The telephoto lens system according to claim 1, wherein an inner diameter of the reflecting area in the rear part of the lens is greater than an outer diameter of the transmitting area in the rear part of the lens.

4. The telephoto lens system according to claim 1, wherein the transmitting area and the reflecting area in the rear part of the lens are connected to each other via an inclined surface extending from an inner diameter of the reflecting area to an outer diameter of the transmitting area.

5. The telephoto lens system according to claim 4, wherein the inclined surface is shaped to converge forward about the optical axis.

6. The telephoto lens system according to claim 4, wherein the inclined surface is provided with a light-blocking means.

7. The telephoto lens system according to claim 4, wherein the inclined surface has a stepped shape.

8. The telephoto lens system according to claim 1, wherein, in light bundles emitted from the object on the optical axis, a ray of light propagating at a height corresponding to 90% of an effective diameter is directed satisfying the following relationship: |ang3|>|ang4|×2 where ang3 indicates an angle of light reflected from the reflecting area in the rear part with respect to the optical axis, and ang4 indicates an angle of light reflected from the reflecting area in the front part with respect to the optical axis.

9. The telephoto lens system according to claim 1, wherein a relationship: TTL/f<0.4 is satisfied, where TTL is a total optical track length or a length from a summit of a front surface of the lens to an imaging surface, and f is a focal length.

10. The telephoto lens system according to claim 1, wherein the lens is formed of a plastic material.

11. The telephoto lens system according to claim 1, further comprising one to three rear lenses arranged on the optical axis and sequentially at a rear of the transmitting area of the rear part of the lens.

12. The telephoto lens system according to claim 11, wherein the rear lens is formed of a plastic material, at least one surface of the rear lens forming an aspheric lens.
